(19) United States
(12) Patent Application Publication
(10) Pub. No.: US 2026/0299600 A1
(43) Pub. Date: Oct. 1, 2026

(54) METHOD FOR TRAVERSING A ROUTE OF AN INDUSTRIAL TRUCK FOR RECEIVING OR DISPENSING A LOAD

(71) Applicant: Jungheinrich Aktiengesellschaft, Hamburg (DE)

(72) Inventors: Sebastian Ulewicz, München (DE); Thomas Leierseder, Furth (DE); Marco Von Krogh, München (DE); Kandarp Gandhi, Freising (DE); Adrian Skulimowski, Landshut (DE); Mario Schwarz, Landshut (DE)

(73) Assignee: Jungheinrich Aktiengesellschaft, Hamburg (DE)

(21) Appl. No.: 19/478,011

(22) PCT Filed: Apr. 23, 2024
(86) PCT No.: PCT/EP2024/061021

§ 371 Date: Oct. 23, 2025

(30) Foreign Application Priority Data
Apr. 24, 2023 (DE) 10 2023 110 320.2

(51) Int. Cl. G05D 1/644; B66F 9/06; B66F 9/075; G05D 1/667; G05D 105/20; G05D 107/70; G05D 109/10; G05D 111/10

(52) U.S. Cl. CPC G05D 1/644; B66F 9/063; B66F 9/0755; G05D 1/667; G05D 2105/20; G05D 2107/70; G05D 2109/10; G05D 2111/17

(57) ABSTRACT

Disclosed is a method for traveling an approach path of an industrial truck for picking up or delivering a load, including the steps of obtaining an ideal target position for picking up or delivering the load, planning a first path to be traveled from the current first location of the industrial truck to the ideal target position on the basis of at least one predetermined first planning criterion, traveling along the planned first path, the industrial truck detecting its surroundings by means of at least one sensor unit while traveling along the planned first path, evaluating the detection data supplied by the at least one sensor unit to determine an actual target position of the load, planning an optimized second path starting from a second location on the first path of the industrial truck to the actual target position on the basis of at least one predetermined second planning criterion, and travelling the planned second path from the second location to the actual target position.

The present application relates to a method for traveling along an approach path of an industrial truck for picking up or delivering a load, and to an industrial truck which is set up to carry out such a method.

In the field of industrial trucks, and in particular autonomous industrial trucks, processes for picking up and delivering loads are an essential part of their regular operation. Different strategies for approaching corresponding loading and unloading positions are conceivable for this purpose, wherein on the one hand it is always desirable to carry out a corresponding approach to such a position in the most efficient way possible, while on the other hand in certain scenarios the position of the load or the delivery position is not known exactly and/or there may be obstacles in the corresponding storage facility that can make it difficult to approach the desired position.

Accordingly, it is necessary to integrate a corresponding procedure for driving along an approach path of the industrial truck to pick up or deliver the load into standard operating sequences, which are often defined by a movement order specified by a control center and also generally include moving to a wider loading area and transporting the load away or removing it from the loading area again after the load has been delivered.

Autonomous industrial trucks used in such systems are usually equipped with a vehicle body pointing in the main direction of travel and a height-adjustable load handling device, such as a load fork, pointing in the opposite direction to the main direction of travel. Accordingly, it is usually necessary to turn the vehicle in order to pick up or deliver a load from the load handling device, as the load handling attachment must be moved forward to the corresponding target position. Furthermore, it should be noted that corresponding industrial trucks that are set up to carry out such operations and execute driving tasks are usually equipped with at least one sensor unit for detecting their surroundings, which is used, for example, to detect obstacles and thereby avoid dangerous situations both for the vehicle itself and for persons in the surroundings of it. In addition, corresponding sensor units can also be provided and used to detect target objects in the surroundings of the industrial truck, for example loads to be picked up or positions to be approached, so that a corresponding control unit of the industrial truck can adapt or regulate the operation of the vehicle within the scope of the current travel task on the basis of the data supplied by the at least one corresponding sensor unit.

It is apparent here that, in particular, the planning and driving of a suitable approach path for picking up or delivering a load has not yet been carried out in an optimal manner in known vehicles of this type or that there is still potential for optimization at this point in order to enable improved integration of this process into the processing of a transport order and, in particular, to improve the flexibility of the vehicle with regard to situations in which an actual load position or delivery position deviates from a corresponding assumed ideal position and therefore an adaptation of the approach process is necessary. Such situations can occur in particular if a load has been moved since it was last set down or has not been placed exactly during the setting down process without the control system being aware of this and consequently either the load itself for a pick-up process or a delivery position adjacent to the load is not or no longer exactly in the position expected by the control system.

For this purpose and for achieving the objective just formulated, the present invention provides a method for traveling an approach path of an industrial truck for picking up or delivering a load, comprising the steps of obtaining an ideal target position for picking up or delivering the load, planning a first path to be traveled from the current first location of the industrial truck to the ideal target position on the basis of at least one predetermined first planning criterion, traveling the planned first path, wherein, while the industrial truck is travelling along the planned first path, its surroundings are detected by means of at least one sensor unit, the detection data supplied by the at least one sensor unit is evaluated to determine an actual target position of the load, an optimized second path is planned from a second location on the first path of the industrial truck to the actual target position on the basis of at least one predetermined second planning criterion, and the planned second path is travelled from the second location to the actual target position.

The method according to the invention is therefore based on dividing an approach path for picking up or delivering a load into a first and a second path, wherein an ideal target position is assumed for planning the first path, which is transmitted to the vehicle by a control center, for example, while the second path is then planned using an actual target position, which is determined by the vehicle itself on the basis of sensor data about its surroundings.

For this purpose, in the method according to the invention, the surroundings are detected while the vehicle is traveling along the first path in such a way that the actual target position is determined, whereupon the planning of the second path is carried out, which can be traveled to the actual target position. Driving on the first path should also expressly include times when the vehicle is stationary while it is on the first path. Accordingly, the last known target position can initially be assumed, which is transmitted to the vehicle, for example, by a control center as part of a driving order or as part of a distance to be driven and already planned, and while approaching this ideal target position, the planning of an optimal approach to the actual target position can take place and, at the second location, a transition can be made from the first path to the second path, thus enabling an optimized execution of the load pick-up or load delivery process. It should be noted at this point that the ideal target position, like the actual target position, can also designate and include an orientation of the load or the delivery location and thus also an alignment of the load or the delivery location in space, as it is only possible to pick up loads carried by pallets at certain approach angles. Accordingly, the term “position” is used in this application to include both a location and an orientation of the load, which is often referred to in this way as a “pose”.

In particular, planning the first path and/or the second path may comprise creating a plurality of candidate paths, discarding candidate paths that cannot be traveled, and selecting an optimal first or second path based on the corresponding at least one predetermined planning criterion. This embodiment makes it possible to first create a number of possible first and/or second paths on the basis of predefined strategies, then to check these for plausibility or navigability and then to select the corresponding optimum path on the basis of the at least one predetermined planning criterion.

Although a parameter space can be covered for this purpose, for example, by varying one or more planning criteria in the form of parameters in a predefined range of values in order to obtain the plurality of candidate paths, in a preferred embodiment the creation of the candidate paths can also comprise an application of modeled patterns to create systematic candidate paths and, if necessary, as a fallback solution, a random creation of fallback candidate paths lying between the systematic candidate paths. In this way, several selected strategies can first be applied to create the systematic candidate paths and then additional alternative candidate paths can be created randomly, for example if none of the systematic candidate paths are determined to be passable. In particular, the pattern models can be parameterized, for example, a start and end pose and an inflection point can be provided in a corresponding model, wherein these poses are then connected by suitable, simple curves using parameters or parameter variations.

Furthermore, the at least one first and/or the at least one second planning criterion can comprise at least one of a shortest distance to be traveled, a smallest and/or largest possible steering angle, an average value of a steering angle, a highest possible speed, a smallest possible travel duration, an avoidance of rotating the industrial truck on the spot and an avoidance of one or more than one turning point. The above examples of corresponding planning criteria represent respective possibilities for optimizing the approach to the target position in order to achieve the most efficient approach possible by the industrial truck.

In particular, the planning of the first path can be carried out along nodes and edges, which already allows greater flexibility at this stage than planning strictly along a predefined path. For example, obstacles that may be in the surroundings can be better taken into account and avoided with such planning, as long as the corresponding nodes of the planned path can be reached or at least approached to a sufficient extent. In other words, an area along the edges and possibly also the nodes can be released for optimization or evasion by the vehicle.

Alternatively or additionally, the planning of the second path can be carried out in such a way that the second location corresponds to a turning point on the planned first path and/or the planning of the second path is carried out a single time. This embodiment takes into account the fact that, particularly in the above described design of vehicles with a load handling device oriented against the main direction of travel, it is necessary to turn the vehicle before picking up or delivering the load, which corresponds to a change in the direction of movement of the vehicle. This change in the direction of movement therefore takes place at the aforementioned turning point. However, scenarios are also conceivable in which the second location, i.e. the point at which the transition from the first path to the second path takes place, must be located after the turning point, for example when entering an alley in which the load or the delivery position is located and which therefore only allows the corresponding position to be detected late. In such cases, for example, the transition from the first path to the second path can only be carried out once the pick-up position or delivery position has been safely and reliably detected.

Although it is conceivable to carry out the planning of the second path a single time on the basis of the determined actual target position, it is alternatively also possible in a further development of the present invention to proceed iteratively when planning the second path and, in particular, to continue to carry out a detection of the surroundings by means of the at least one sensor unit and an evaluation of the detection data supplied by the at least one sensor unit for determining an actual target position of the load during the travel of the second path and, if necessary, to further optimize the second path iteratively during its travel. This measure achieves a further increase in the precision of the approach to the target position due to the additional data obtained with regard to the actual target position while traveling along the second path. However, it is preferable that the planning of the second path begins before passing a turning point for the approach to the actual target position. The reason for this is that the position of the turning point or points in space is particularly important for an efficient approach to the actual target point. Depending on how the turning point is positioned and oriented relative to the current position of the industrial truck and the actual target point, the approach can be particularly efficient or inefficient, as a comparatively small or particularly large steering angle is required to pass through the turning point, for example, wherein the maximum speed of the vehicle may be limited if the steering angle is large.

Furthermore, in the method according to the invention, different first planning criteria can be used outside and within a predetermined minimum distance between the industrial truck and the ideal target position while traveling along the first path and/or the evaluation of the detection data to determine the actual target position of the load can be carried out only within the predetermined minimum distance. An example of this can be that the first path initially comprises a clear, specific first section to be traveled, which is traveled until the predetermined minimum distance to the ideal target position is reached. The vehicle can then be given a greater degree of freedom when planning a second section of the first path, and this planning can take place using the nodes and edges already mentioned above, for example. Thus, the first path is divided into two sections in which different strategies for its planning are pursued, and it is additionally or alternatively conceivable to carry out the evaluation of the detection data to determine the actual target position of the load also only within this radius with increased planning freedom around the ideal target position.

In an alternative example, the entire planning of the first path could also take place on the basis of nodes and edges, although within the predetermined minimum distance a greater deviation from the predetermined edges and possibly nodes would be permitted compared to the area outside the predetermined minimum distance. In particular, the planning of the first path can in any case be carried out in practice in such a way that the nodes and edges thereof are specified by a control center to the vehicle, which then carries out the concrete planning of the first path on this basis, wherein it can have different degrees of planning freedom within and outside the predetermined minimum distance with regard to compliance with the specified nodes and edges. In such a specific case, both the nodes and edges as well as the specifications regarding the vehicle's freedom to plan the specific path should be understood as initial planning criteria.

For the sake of completeness, it should also be mentioned at this point that it is also conceivable in principle to adapt the first and/or second planning criteria within the first and/or second path, for example within the framework of logical subsections, in order to enable dynamic and/or further optimized generation of the corresponding paths. For example, it could be considered to only allow straight-ahead driving from a certain distance to the actual target position, corresponding to a steering angle of the vehicle of zero.

Furthermore, according to the invention, the evaluation of the detection data to determine an actual target position of the load can only be carried out within a predetermined range around the ideal target position. In this way, a region of interest is defined around the ideal target position and the corresponding processing of the sensor data to determine the actual target position is only carried out within this region to increase the efficiency of the method. Depending on the sensor unit used, only the corresponding region can be detected, i.e. the area detected by the sensor unit can be restricted to the region of interest, or the software can be used to restrict the processing of the sensor data to this region.

Furthermore, in the method according to the invention, determining the actual target position may comprise checking whether the actual target position is within a predetermined range around the ideal target position. This check represents both a plausibility check and a safety mechanism, as it can rule out the possibility of target positions being mixed up, for example if a load other than that scheduled to be picked up by the vehicle is used as the basis for determining the actual target position. On the other hand, even if the correct load or delivery position is detected, it can also be ruled out that there are excessive deviations between the ideal and the actual target position, which could indicate that there is a major problem in the corresponding area of the logistics facility, for example, that loads have been moved considerably in the meantime in an undesirable manner that has not been made known to the control center. If, as a result, too great a distance is detected between the ideal and the actual target position, suitable countermeasures could be initiated, for example the approach to the target position could be aborted and corresponding warnings issued.

Although different procedures for determining the actual target position are conceivable, which may depend, among other things, on the types of sensor units used and also on the load to be transported, evaluating the detection data to determine the actual target position of the load may involve searching the detection data for predetermined patterns, which may, for example, correspond to the known shape of the load. This strategy can be used for both planned pick-up and delivery of the load, as suitable delivery positions for loads can also ultimately depend on their shape. An example of such a procedure may consist of searching the data supplied by the at least one sensor unit, in this case in particular a laser scanner or a 3D camera, for patterns that correspond to a pallet with known dimensions as the load to be picked up. Neural networks or other techniques from the field of artificial intelligence could also be used for this purpose. Regardless of the specific method used, however, it is also possible to reliably determine the orientation of the load, which can also be derived from the corresponding sensor data using suitable algorithms.

Similarly, depending on the type of sensor used, the detection of the surroundings by means of the at least one sensor unit can be carried out in a periodic manner and a determination of the actual target position can be made only when the load or the delivery position is detected several times during the periodic detection and/or the actual target position can be obtained by averaging several specific positions of the load of the delivery position. These additional measures also contribute to the plausibility check and improvement of the precision of the actual target position, wherein in particular a minimum number of detections of the load can be specified, from which the actual target position is considered to be determined and/or it can be required that a corresponding detection must have taken place in successive cycles of the detection process. In addition, a consistency check of several specific items can be carried out using predefined criteria, wherein the method can be aborted or individual entries discarded if the results are inconsistent. Also conceivable are embodiments in which the averaging of the several specific positions takes place in a weighted or unweighted manner, whereby, for example, certain positions with a higher weight could be included in the averaging from a smaller distance.

During the last section of the approach to the actual target position when traveling along the second path, i.e. when the load is about to be picked up or delivered, if the distance between the industrial truck and the actual target position falls below a predetermined target distance while traveling along the second path, at least one of switching a protective field of the at least one sensor unit to a special mode can be executed, moving a load handling device of the industrial truck to a predetermined height and activating a load shift detection, in particular by means of the at least one sensor unit for detecting the surroundings and/or by means of a dedicated further sensor unit. In this case, the mentioned load shift detection can, for example, remain activated while the load handling device of the vehicle is driving into a pallet acting as a load and/or a load detection can be carried out with regard to a correct pick-up thereof on the load handling device.

According to a second aspect, the present invention relates to an industrial truck, in particular an autonomous industrial truck, comprising at least one sensor unit for detecting the surroundings of the industrial truck and a control unit coupled to the at least one sensor unit, which control unit is in particular adapted to manage an autonomous operation of the industrial truck, wherein the industrial truck is adapted to perform the method according to the invention just described.

One or more 3D cameras could be used as the at least one sensor unit, but it is also conceivable to design the at least one sensor unit as a laser scanner, which preferably allows all-round detection or is aligned in the load direction of the industrial truck and/or simultaneously serves as a safety sensor. In such embodiments with laser scanners, protective fields are usually activated as a safety function, i.e. areas are defined around the vehicle in which objects or persons may not be located or may only be located in defined exceptional cases in order to avoid collisions or accidents.

It should be noted here that the execution of the method according to the invention, in particular the requirement for planning a second path for approaching an actual target position, arises in particular for vehicles that are not able to rotate on the spot or are only able to do so very slowly. For example, vehicles that are designed as underfloor trucks and pick up a load by lifting it from below are often equipped with two independently electric motor-driven wheels and are therefore able to rotate very quickly on the spot by driving the wheels in opposite directions. In contrast, industrial trucks with a classic design, i.e. with a load fork as the load handling device, are often equipped with one or more non-driven and/or non-steered rollers on the load part, in particular per fork, and one or more driven and steered wheels on the vehicle body or drive part. Due to this asymmetrical design, rotating or turning on the spot is not possible or only possible very slowly and, depending on the design and in particular the wheelbase, requires significantly more space than vehicles whose pivot point is geometrically centered. For the most efficient approach of the load, it is therefore particularly advantageous for these vehicles if the approach is planned individually for the vehicle based on the actual target position.

Finally, it should also be pointed out that the control unit of the industrial truck according to the invention can also be set up to optionally perform an alternative operation in which a path to the ideal target position is planned and traveled directly without determining the actual target position. In such a case, the corresponding path could then be planned in a similar way to the planning of the first path described above using predetermined planning criteria, for example again using edges and nodes.

Further features and advantages of the present invention will become even clearer from the following description of embodiments thereof, when considered together with the accompanying figures. These show in detail:

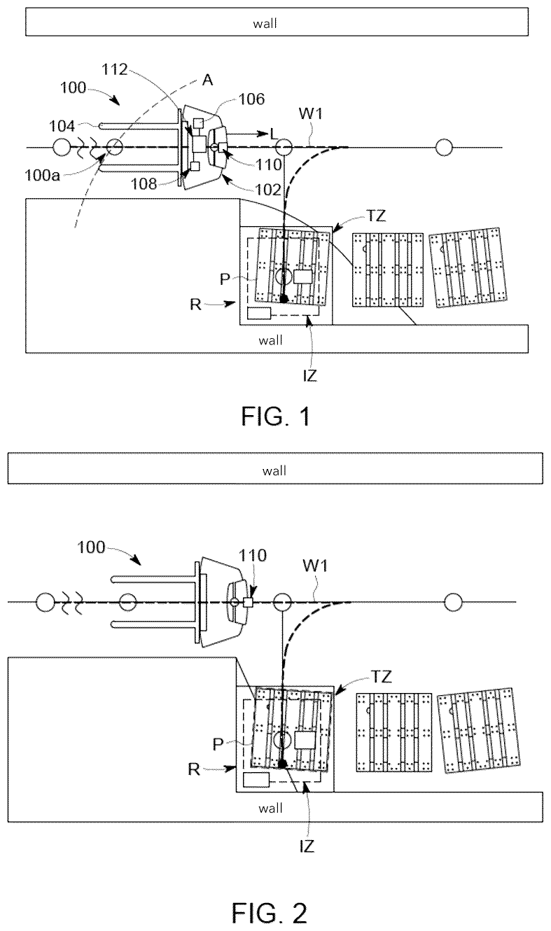

FIGS. 1-6: schematic views of an industrial truck according to the invention during the execution of a method according to the invention

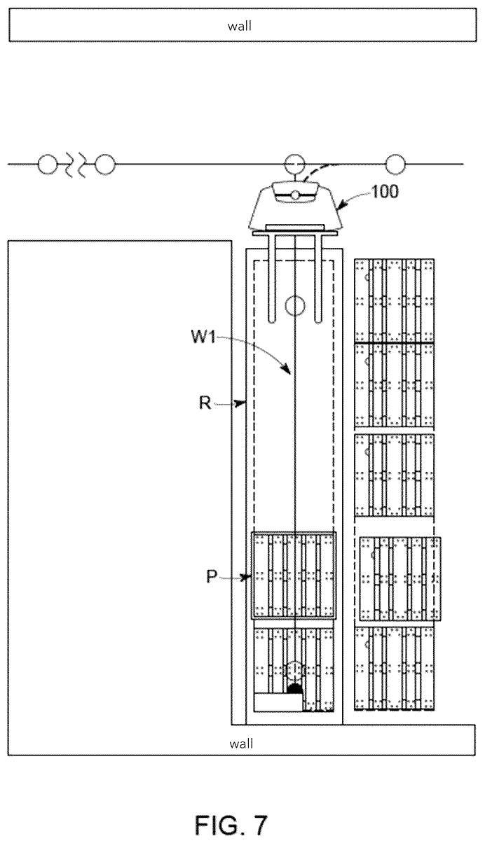

FIG. 7: schematic view of an alternative scenario which may occur during the method according to the invention of FIGS. 1-6 ; and

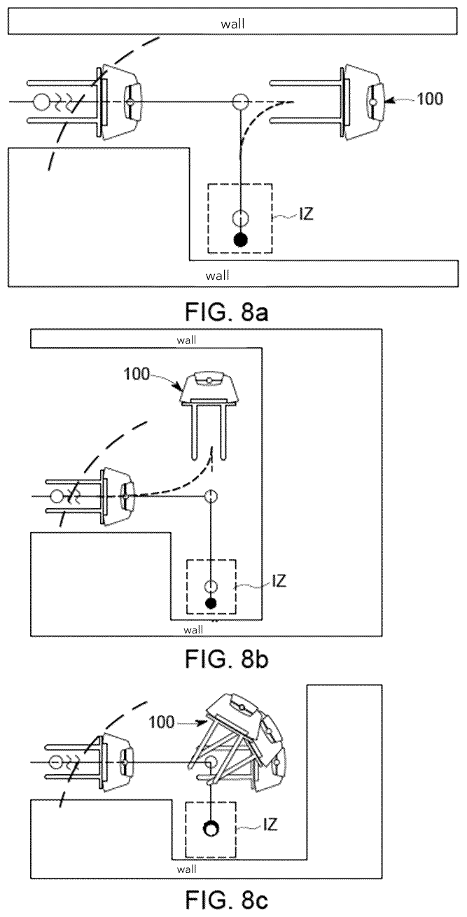

FIGS. 8a-8c: schematic views of further scenarios which can occur during the method according to the invention from FIGS. 1-6 .

In all of the figures discussed below, a schematic top view of an industrial truck 100 according to the invention is shown, which is set up and intended for carrying out the method according to the invention described with reference to the figures within a logistics facility. In this case, the industrial truck 100 is formed as an autonomous industrial truck with a vehicle body 102 and a load handling device 104 in the form of a fork, which is arranged thereon so as to be vertically displaceable, and at least three wheels, which cannot be seen in the figures and by means of which the industrial truck 100 can move on the ground in a driven and steered manner. For reasons of clarity, the components of the vehicle 100 described below are only shown in FIG. 1.

In particular, the industrial truck 100 is in communication with a control center by means of a communication device 106, from which travel orders are transmitted to the industrial truck, which in the example discussed here relate in particular to picking up or delivering a load in the form of a pallet P at a target position. Here, the control center is initially aware of an ideal target position IZ of the pallet P, at which the pallet P or the delivery position should be located according to the knowledge of the control center, for example because a pallet was placed at this position during an earlier process or there is currently a suitable free space for delivering a pallet already carried by the vehicle 100. The ideal target position IZ includes not only the location but also the orientation of the pallet P or the delivery position, as it is particularly important when picking up pallets to plan the approach in such a way that the load handling device 104 moves into the pallet pockets. In the following, a method according to the invention will be described in particular, in which a pallet P is to be picked up at a target position by the industrial truck 100.

For this purpose, the industrial truck 100 further comprises a position determination device 108 with which it can determine its own position in space, for example in relation to a reference system tailored to the logistics equipment in question.

Various strategies for determining position are conceivable for this purpose; for example, active transmitters or passive markings could be provided in the logistics equipment, which the industrial truck 100 can use to determine its own relative position by means of the position determination device 108. Similarly, however, the position determination device 108 could also comprise a suitable camera or a laser scanner, wherein the own position of the industrial truck 100 could then be derived from the images recorded by this camera by means of pattern recognition. In addition, it would be conceivable to provide an odometry device as part of the position determination device 108, which can, for example, determine a number of wheel rotations and a steering angle of at least one of the wheels and from this can determine a distance traveled since a last known location and thus a current position.

Furthermore, the industrial truck 100 comprises at least one sensor unit 110 for detecting its surroundings, which can be designed in particular as a laser scanner and is arranged in the load direction of the industrial truck 100, for example to cover a scanning range of approximately 180°. Alternatively, a distributed provision of several laser scanners on the industrial truck 100 would also be conceivable, for example in order to be able to capture the entire surroundings of the vehicle 100 over a full 360°.

Such laser scanners periodically sweep a predetermined scanning angle, for example at a frequency of around 20 Hertz, and output corresponding two-dimensional or three-dimensional detection data. In the present case, the sensor unit 110 serves on the one hand as a safety device, which creates a protective field in the surroundings of the vehicle 100, wherein a suitable measure can be initiated if an object or person is detected within the protective field of the sensor unit 110, for example by issuing an alarm, slowing down or even completely braking the vehicle 100. On the other hand, the sensor unit 110 is used to determine the actual target position TZ as part of the method described below, as will be explained further below.

Operationally coupled to the communication device 106, the position determination device 108 and the at least one sensor unit 110, the industrial truck 100 further comprises a control device 112, which manages travel orders received from the control center, controls the operation of the industrial truck 100 and its components within the framework of the travel orders and, in particular, is set up to carry out the method according to the invention described below.

Reference is first made to FIG. 1, in which the industrial truck 100 has already received a movement order from the control center, which in particular comprises an assumed ideal target position IZ of the pallet P to be picked up, the expected load type, i.e. the specific shape of the pallet P to be picked up, a region of interest R within which the pallet P may be located and within which the pallet P is consequently searched for, and a minimum distance A to the ideal target position IZ. Both the region of interest R and the minimum distance A can be stored in the vehicle as a defined area around the ideal target position IZ, wherein both do not necessarily have to be circular, but can in principle have any shape, for example rectangles, polygons or similar. In the specific case shown in FIG. 1, however, the minimum distance A is shown as a dashed circle section and is sometimes referred to as the “free roam radius”, as the vehicle 100 is allowed to move more freely once this minimum distance A is reached.

In FIG. 1, the industrial truck is located precisely with its vehicle reference point 100a provided for this purpose at the minimum distance A, wherein it has traveled on a path up to this position, which has been created with a relatively low degree of planning freedom using at least one predetermined planning criterion, for example using edges and nodes, and forms a first section of a first path W1 to the pallet P to be picked up, which is still created on the basis of the assumed ideal target position IZ. When entering the area within the minimum distance A, the vehicle 100 is now able to plan its path more freely using the nodes and edges mentioned, which are also indicated in the figures, wherein the vehicle 100 is allowed, for example, to take into account obstacles present in its range of movement, as will be explained below with reference to FIGS. 8a-8c. This planning of the second section of the first path continues to be based on the ideal target position IZ and, in the example shown here, comprises turning the vehicle 100 in order to be able to drive into the pockets of the pallet P in the assumed ideal target position IZ with the load handling device 104 and lift it.

In the example discussed here, detection of the actual target position TZ, i.e. the actual position and orientation of the pallet P in space, also begins at the time of entry into the area within the minimum distance A. In some cases, this will differ from the ideal target position IZ by a certain amount, although it is nevertheless required that the actual target position TZ lies within the region of interest R. However, in alternative variants of the method according to the invention, the detection of the actual target position TZ could also start at an earlier or later point in time and not necessarily when entering the area within the minimum distance A.

In any case, for this purpose of recognizing the actual target position TZ, the detection data supplied by the sensor unit 110 is evaluated and, in particular, searched for patterns which correspond to the known shape of the pallet P or generally to a plurality of permissible pallet shapes. This shows that the pallet P in the constellation shown in FIG. 1 is not yet visible to the sensor unit 110, as it is shadowed by a wall. Accordingly, the vehicle 100 continues to move along the planned first path W1, which is indicated by a dashed line in FIG. 1.

After a certain distance has been covered on this first path and the vehicle has reached the position shown in FIG. 2, the pallet P will be completely visible from one side and a pattern corresponding to the known pallet type will be recognized in the data supplied by the sensor unit 110. Accordingly, a determination of the actual target position TZ can be carried out from this point in time, wherein a plurality of target positions can be successively determined due to the periodic mode of operation of the sensor unit 110, which can be used for a plausibility check or an improvement in the precision of the actual target position TZ.

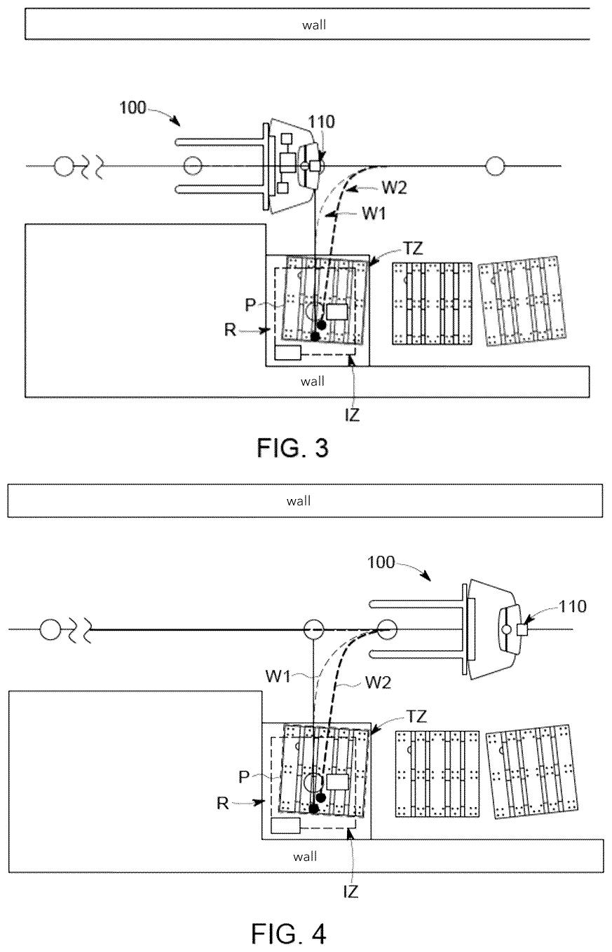

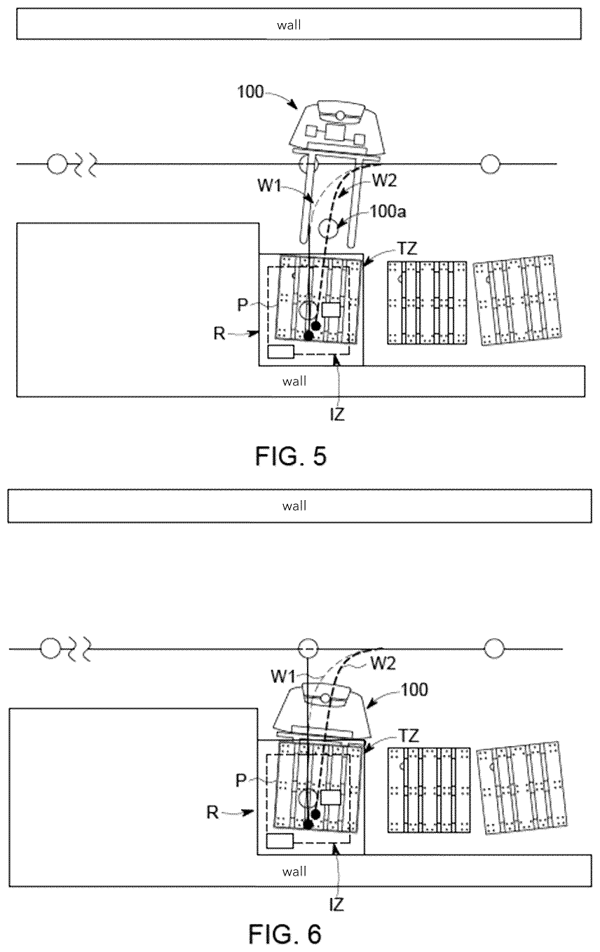

After the actual target position TZ has been determined with sufficiently high confidence on the basis of a number of individual measurements, it becomes apparent that there is a deviation between the ideal target position IZ and the actual target position TZ and therefore the previously planned first path W1 is not optimal for picking up the pallet P, as it would prevent the load handling device 104 from moving into the pallet pockets in an ideal manner. Accordingly, in the state shown in FIG. 3, a second path W2 is planned on the basis of the determined actual target position TZ using at least one predetermined second planning criterion, which in the example shown here begins at the turning point of the first path W1 and ends with a correct entry into the pallet pockets of the pallet P at the actual target position TZ. Accordingly, the vehicle 100 first travels to the turning point along the first path W1, as shown in FIG. 4, and then, as shown in FIG. 5, continues along the second path W2, whereby the paths are each again related to the reference point 100a.

While it is possible in principle to carry out a single planning of the second path W2, the position of the pallet P can alternatively continue to be detected and evaluated during movement on the second path W2 between the states shown in FIG. 4 and FIG. 5, so that iterative adaptation of the second path W2 is possible at this time, if desired and necessary.

When the actual target position TZ shown in FIG. 5 is reached or the distance between the industrial truck when the distance between the industrial truck 100 and the actual target position TZ falls below a predetermined target distance, further processes can also be triggered, for example the protective field of the sensor unit 110 can be switched to a special field in order not to identify the pallet P to be picked up as an obstacle, the load handling device 104 can be lowered to a predetermined height and a load shift detection can be activated, wherein either the sensor unit 110 can carry out a detection of a front edge of the pallet P or a dedicated further sensor unit can be used, for example an analog distance or contact sensor.

During the entry of the load handling device 104 shown in FIG. 6, a check is also carried out to determine whether the pallet P is being displaced, but it is difficult for the sensor unit 110 to detect this due to the angle, so that an additional sensor unit is preferably used. Furthermore, an additional pallet sensor provided in the area of the load handling device 104 can confirm that the pallet P has been correctly picked up over the last few millimeters of its entry into the pallet pockets.

FIG. 7 now shows an alternative scenario that can occur during the method according to the invention shown in FIGS. 1-6 . This is because the pallet P to be picked up is arranged within a pallet lane, so that it cannot yet be sufficiently recognized before the vehicle 100 turns on the first path W1. As a result, in this variant the path W1 planned on the basis of the assumed ideal target position IZ will be used until after the turning point and only when the straight approach to the pallet P is reached will it be possible and possible to plan a second path as soon as the pallet P has been detected with sufficient confidence. Here, however, it is necessary that the sensor device 110 can also detect its surroundings in the direction of the load handling device 104 in order to be able to determine the actual position TZ at this late stage of the approach of the pallet position.

Similarly, FIGS. 8a-8c indicate further scenarios that can occur during the process according to the invention shown in FIGS. 1-6 . In particular, the space available for the turning process of the vehicle 100 may be limited, so that the planning of the first and possibly second path must be adapted accordingly. Although the turning process shown in FIGS. 1-6 is an optimal option, since the travel time required by the vehicle 100 is minimized and consequently the method can be carried out particularly efficiently, the present invention also permits in particular the planning of alternative approaches which avoid walls or other known obstacles in the surroundings of the pallet P or even comprise maneuvering with multiple turning or rotating on the spot, as indicated in FIG. 8c.

Finally, it should be pointed out that although the present figures show a process for picking up a load, a process for delivering a load can also be carried out in a similar way, in which case a suitable target position can be determined by the fact that it is free of objects and its dimensions allow the load to be delivered.

1. Method of traveling along an approach path of an industrial truck for picking up or delivering a load, comprising the steps of:
obtaining an ideal target position for picking up or delivering the load
planning a first path to be traveled from a current first location of the industrial truck to the ideal target position, using at least one predetermined first planning criterion;
driving along the planned first path, wherein, while the industrial truck is traveling along the planned first path, its surroundings are detected by means of at least one sensor unit;
evaluating the detection data supplied by the at least one sensor unit to determine an actual target position of the load;
planning an optimized second path starting from a second location on the first path of the industrial truck to the actual target position on the basis of at least one predetermined second planning criterion; and
traveling the planned second path from the second location to the actual target position.

2. Method according to claim 1, wherein the planning of the first path and/or the second path comprises:
creating a number of candidate paths;
discarding candidate paths that cannot be used; and
selecting an optimum first or second path on the basis of the corresponding at least one predetermined planning criterion.

3. Method according to claim 2,
wherein the creation of the candidate paths comprises an application of modeled patterns for the creation of systematic candidate paths and, if necessary, as a fallback solution, a random creation of fallback candidate paths lying between the systematic candidate paths.

4. Method according to claim 1,
wherein the at least one first and/or the at least one second planning criterion comprises at least one of:
a shortest distance to be traveled;
a smallest and/or largest possible steering angle;
an average value of a steering angle;
the highest possible speed;
the shortest possible travel time;
avoidance of rotating the industrial truck on the spot; and
avoidance of one or more than one turning point.

5. Method according to claim 1,
wherein the planning of the first path is carried out along nodes and edges.

6. Method according to claim 1,
wherein the planning of the second path is carried out in such a way that the second location corresponds to a turning point on the planned first path and/or the planning of the second path is carried out a single time.

7. Method according to claim 1,
wherein, during traveling along the second path the surroundings are furthermore detected by means of at least one sensor unit and the detection data supplied by the at least one sensor unit is evaluated in order to determine the actual target position of the load, and
if necessary, the second path is iteratively further optimized during its travel.

8. Method according to claim 1,
wherein different first planning criteria are used outside and within a predetermined minimum distance between the industrial truck and the ideal target position during traveling along the first path and/or the evaluation of the detection data for determining the actual target position of the load is performed only within the predetermined minimum distance.

9. Method according to claim 1,
wherein the evaluation of the detection data to determine the actual target position of the load is only carried out within a predetermined range around the ideal target position.

10. Method according to claim 1,
wherein determining the actual target position comprises checking whether the actual target position is within a predetermined range around the ideal target position.

11. Method according to claim 1,
wherein the evaluation of the detection data to determine the actual target position of the load comprises searching the detection data for predetermined patterns which correspond, for example, to the known shape of the load.

12. Method according to claim 1,
wherein the detection of the surroundings by the at least one sensor unit is performed in a periodic manner; and
the actual target position is only determined if the load or the delivery position is detected several times during the periodic detection; and/or
the actual target position is obtained by averaging several specific positions of the load or the delivery position.

13. Method according to claim 1,
wherein when the distance between the industrial truck and the actual target position falls below a predetermined target distance while traveling along the second path, at least one of the following operations is carried out:
switching a protective field of the at least one sensor unit to a special field;
moving a load handling device of the industrial truck to a predetermined height; and
activating a load shift detection, in particular by means of the at least one sensor unit for detecting the surroundings and/or by means of a dedicated further sensor unit.

14. Industrial truck, in particular autonomous industrial truck, comprising:
at least one sensor unit for detecting the surroundings of the industrial truck and
a control unit coupled to the at least one sensor unit, which is set up in particular to manage an autonomous operation of the industrial truck;
wherein the industrial truck is adapted to perform a method according to claim 1.

15. Industrial truck according to claim 14, comprising
a load part with at least one unsteered and/or unpowered wheel; and
a vehicle body with at least one steered drive wheel.

16. Industrial truck according to claim 14,
wherein the at least one sensor unit is designed as a laser scanner, which preferably permits all-round detection or is aligned in a load direction of the industrial truck and/or simultaneously serves as a safety sensor.

17. Industrial truck according to claim 14,
wherein the control unit is also set up to optionally perform an alternative operation in which a path to the ideal target position is planned and traveled directly without determining the actual target position.
